(19) United States
(12) Patent Application Publication
(10) Pub. No.: US 2025/0175826 A1
(43) Pub. Date: May 29, 2025

(54) MOBILE BODY AND WIRELESS COMMUNICATION DEVICE

(71) Applicant: TOYOTA JIDOSHA KABUSHIKI KAISHA, Toyota-shi (JP)

(72) Inventors: Masaru TAKADA, Toyota-shi (JP); Toru FURUSAWA, Yokohama-shi (JP); Xiao SHAO, Kawasaki-shi (JP)

(73) Assignee: TOYOTA JIDOSHA KABUSHIKI KAISHA, Toyota-shi (JP)

(21) Appl. No.: 18/953,657

(22) Filed: Nov. 20, 2024

(30) Foreign Application Priority Data
Nov. 24, 2023 (JP) 2023-199335

(51) Int. Cl. H04W 24/08; G01C 21/34; H04W 4/024

(52) U.S. Cl. CPC H04W 24/08; G01C 21/3461; H04W 4/024

(57) ABSTRACT

A mobile body comprises a wireless communication unit and a processor, wherein the processor is configured to: receive communication quality messages from a plurality of other mobile bodies by the wireless communication unit, the communication quality messages including position information and communication quality information about a position indicated by the position information, determine a destination based on the communication quality messages, and present information about the destination to a user.

### CROSS REFERENCE TO THE RELATED APPLICATION

This application claims the benefit of Japanese Patent Application No. 2023-199335, filed on Nov. 24, 2023, which is hereby incorporated by reference herein in its entirety.

### BACKGROUND

### Technical Field

The present disclosure relates to a mobile body and a wireless communication device.

### Description of the Related Art

Japanese Patent Laid-Open No. 2017-167625 discloses that an autonomous mobile device creates a communication quality map while moving, and uses the communication quality map for route search.

However, according to such a method, only communication quality at a position where the autonomous mobile device traveled can be grasped, and control cannot be performed while taking into account communication quality at surroundings.

### SUMMARY

A mode of the present disclosure is aimed at providing a mobile body and a wireless communication device that are capable of more suitably acquiring communication quality in surroundings and of using the communication quality for control.

One aspect of the present disclosure is a mobile body comprising a wireless communication unit and a processor, wherein the processor is configured to:
receive communication quality messages from a plurality of other mobile bodies by the wireless communication unit, the communication quality messages including position information and communication quality information about a position indicated by the position information,
determine a destination based on the communication quality messages, and
present information about the destination to a user.

One aspect of the present disclosure is a mobile body comprising a wireless communication unit and a processor, wherein the processor is configured to:
receive communication quality messages from a plurality of other mobile bodies by the wireless communication unit, the communication quality messages including position information and communication quality information about a position indicated by the position information,
create a communication quality map for each position based on the communication quality messages, and
search for a route to a destination based on the communication quality map, and present the route to a user or move along the route.

One aspect of the present disclosure is a wireless communication device comprising a processor configured to:
receive communication quality information from a plurality of other wireless communication devices,
select at least one wireless communication device from the plurality of other wireless communication devices based on the communication quality information, and
request the other wireless communication device that is selected, to relay communication through a base station.

The mobile body or the wireless communication device is able to acquire communication quality in surroundings and use the communication quality for control.

### BRIEF DESCRIPTION OF THE DRAWINGS

FIG. 1 is a diagram describing an outline of a system of an embodiment;

FIG. 2 is a diagram illustrating a configuration of a vehicle (a mobile body) according to the embodiment;

FIG. 3 is a flowchart of a communication quality acquisition process performed by the vehicle in the embodiment;

FIG. 4 is a flowchart illustrating a flow of a destination determination process according to a first embodiment;

FIG. 5 is a flowchart illustrating a flow of a route search process according to a second embodiment;

FIG. 6 is a flowchart illustrating a flow of a communication relay process according to a third embodiment; and

FIG. 7 is a flowchart illustrating a modification of the flow of the communication relay process according to the third embodiment.

### DESCRIPTION OF THE EMBODIMENTS

### Outline

These days, large-capacity data transmission/reception through wireless communication is made possible. For example, 5G communication standards allow high-speed, large-capacity communication of 10 Gbps or more. However, communication quality of wireless communication varies depending on a position, and being at a position with a good communication quality is desirable to perform high-speed, large-capacity wireless communication. It is conceivable to determine a position with a good communication quality based on a map statistically indicating the communication quality, but the communication quality also changes over time; therefore a position that has a good communication quality at a given time is not necessarily determined. A case is also conceivable where a device creates a communication quality map by moving while measuring the communication quality, but with such a method, the communication quality at a position not experienced by the device cannot be grasped, and also, a past communication quality does not necessarily coincide with the communication quality at a present time point.

Accordingly, the present disclosure aims at acquiring the communication quality in surroundings, and performing control based on such communication quality.

The present disclosure includes a mode where a position with a good communication quality is determined, and the position or a route to the position is presented, for example. The present disclosure also includes a mode where, when searching for a route to a destination, a route that passes through a position with a good communication quality is searched, for example. Moreover, the present disclosure also includes a mode where a device present at a position with a good communication quality is requested to relay communication, for example.

A mode of the present disclosure is a mobile body including a wireless communication unit and a processor, where the processor is configured to receive communication quality messages from a plurality of other mobile bodies by the wireless communication unit, the communication quality messages including position information and communication quality information about a position indicated by the position information, determine a destination based on the communication quality messages, and present information about the destination to a user.

In the present mode, the processor may take a position where the communication quality is at or higher than a predetermined standard to be the destination. Furthermore, a typical example of the information about the destination is information about a position of the destination, and is, more specifically, the position itself of the destination or a route to the destination.

According to the present mode, a user of the mobile body is able to grasp a position with a good communication quality. For example, if a position with a good communication quality can be grasped at a time of performing large-capacity communication, large-capacity communication can be performed by performing communication after moving the mobile body to the position.

Another mode of the present disclosure is a mobile body comprising a wireless communication unit and a processor, wherein the processor is configured to:
receive communication quality messages from a plurality of other mobile bodies by the wireless communication unit, the communication quality messages including position information and communication quality information about a position indicated by the position information,
create a communication quality map for each position based on the communication quality messages, and
search for a route to a destination based on the communication quality map, and present the route to a user or move along the route.

In the present mode, the processor may preferentially search for a route where the communication quality is at or higher than a predetermined standard, based on the communication quality map. Additionally, the communication quality does not have to be at or higher than the predetermined standard along the entire route, and a route including a part with a poor communication quality may be searched as long as the communication quality of the communication route as a whole satisfies the predetermined standard. Moreover, the communication quality does not have to be at or higher than the predetermined standard along the entire route, and a route where the communication quality satisfies the predetermined standard in a predetermined period of time (such as a period of time when large-capacity communication is predicted to occur) may be searched.

In the present mode, the destination may be input by a user, or the processor may determine the destination based on the communication quality information received from other mobile bodies or a communication quality map created based on the communication quality information.

Another mode of the present disclosure a wireless communication device comprising a processor configured to:
receive communication quality information from a plurality of other wireless communication devices,
select at least one wireless communication device from the plurality of other wireless communication devices based on the communication quality information, and
request the other wireless communication device that is selected, to relay communication through a base station.

According to the present mode, by performing communication through another wireless communication device that is at a position with a good communication quality, a wireless communication device is able to perform large-capacity communication without moving to a position with a good communication quality.

In the present disclosure, the communication quality may be a received radio wave strength, a reception quality, a signal-to-interference-plus-noise ratio, or communication throughput, for example.

The present disclosure further includes a computer program for causing a computer to perform each step of the method described above, and a computer program for implementing a network node described above or an information processing system using a computer. The present disclosure further includes a computer-readable medium storing the computer program.

### First Embodiment

Hereinafter, embodiments of the present disclosure will be described with reference to the drawings. The following embodiments are merely examples for descriptive purpose, and the present disclosure is not limited to configurations of the embodiments. For example, in the following, an example is described where mobile communication, or more particularly, mobile communication according to 5G standards, is used, but mobile communication according to standards other than 5G or wireless communication other than mobile communication may also be used.

### Outline of System

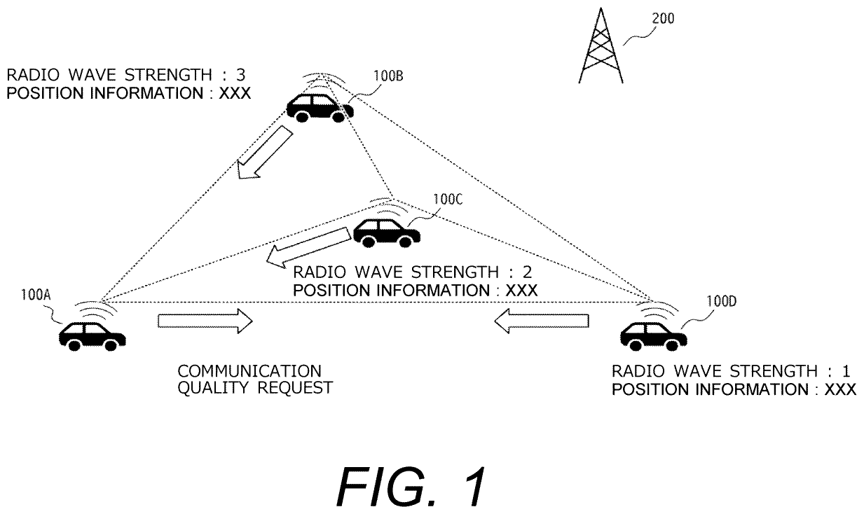

FIG. 1 is a diagram describing an outline of a system according to the present embodiment. The present system includes a plurality of vehicles 100A to 100D. Additionally, in the following, when it is not necessary to distinguish each vehicle, vehicle(s) 100 will be used as a collective term.

The vehicle 100 includes a wireless communication device compatible with mobile communication (such as 5G), and is capable of communication through a base station 200 and a 5G core system (5GCS) and direct communication between the vehicles 100 using sidelink (SL).

Here, it is assumed that the vehicle 100A is scheduled to perform large-capacity communication but a current radio wave environment is not good and large-capacity communication is desired to be performed by moving to a position with a better radio wave environment and, in turn, communication quality. Accordingly, the vehicle 100A acquires information about the communication quality from the vehicle 100B to 100D in surroundings, and performs large-capacity communication by moving to a position with a good communication quality.

### Configuration

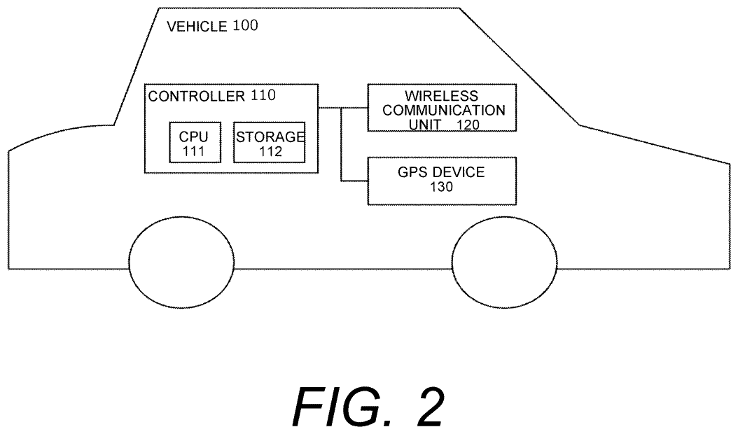

FIG. 2 is a diagram illustrating an example configuration of the vehicle 100. The vehicle 100 includes a controller 110, a wireless communication unit 120, and a GPS device 130.

The controller 110 includes a CPU 111 and a storage 112, and implements functions described below by executing computer programs loaded in the storage 112 by the CPU 111. There may be one or more CPUs 111, or one CPU may be multi-core. The controller 110 may include other processors such as a GPU and a DSP, in addition to the CPU. The storage 112 includes a volatile memory such as a RAM, and a non-volatile memory such as an SSD, an HDD, or a flash memory. The controller 110 may be assumed to be an information processing apparatus or a computer.

The wireless communication unit 120 is a communication device that is compatible with mobile communication standards, for example, and includes a signal oscillator, a modulator/demodulator, an amplifier, an antenna, and the like. For example, the wireless communication unit 120 is compatible with 5G communication standards, and is able to perform communication through the base station (gNB) 200 or direct communication with another vehicle 100 using sidelink (SL).

The GPS device 130 is a device that performs position measurement based on a GPS satellite signal, and is capable of acquiring a current position of the vehicle 100.

### Process

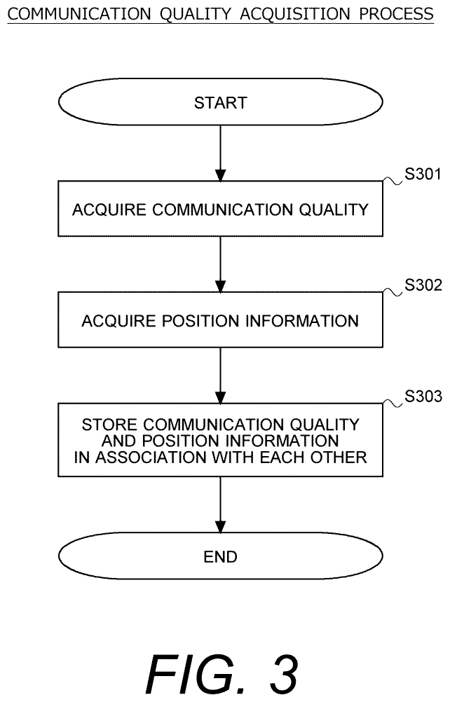

FIG. 3 is a flowchart illustrating a flow of a communication quality acquisition process that is performed by the vehicle 100 on a regular basis. The process may be executed at a specific time interval (such as 1 second, 5 seconds, 10 seconds, 30 seconds, or 1 minute), or may be executed every time traveling is performed over a specific distance or every time a predetermined trigger occurs, for example.

In step S301, the controller 110 acquires the communication quality at a current time point. The communication quality may be a received radio wave strength (such as reference signal received power (RSRP)), a reception quality (such as reference signal received quality (RSRQ)), or a signal-to-interference-plus-noise ratio (SINR) obtained from the wireless communication unit 120, or may be end-to-end communication throughput that can be grasped by the controller 110.

In step S302, the controller 110 acquires position information about a current location from the GPS device 130. Additionally, the position information may be acquired by a sensor other than the GPS device 130 or through analysis of a camera image, for example.

In step S303, the controller 110 stores the communication quality acquired in step S301 and the position information acquired in step S302 in the storage 112 in association with each other.

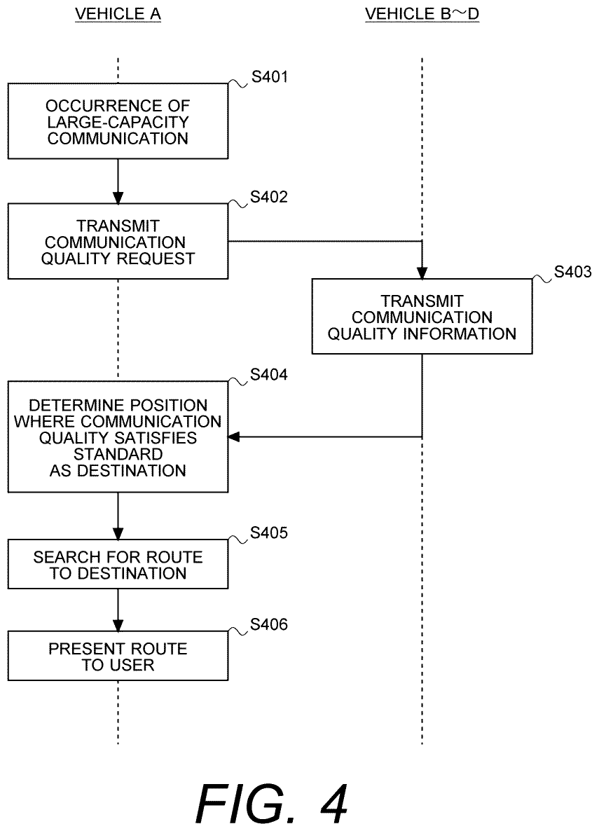

FIG. 4 is a flowchart illustrating a flow of processes that are performed at a time when the vehicle 100A performs large-capacity communication. The following description describes that the vehicle 100 performs the processes, but more precisely, the processes are performed by the controller 110 of the vehicle 100.

The processes in FIG. 4 are started when there is occurrence of a request for large-capacity communication at the vehicle 100A in step S401. Additionally, a request for large-capacity communication includes, in addition to a case where communication is to be instantly started, a case where communication is scheduled to be performed after a predetermined period of time.

In step S402, the vehicle 100A transmits a request message requesting communication quality information to the vehicle 100B to 100D in the surroundings via the wireless communication unit 120. The request message may include an identifier of the vehicle 100A and a current position of the vehicle 100A. In the present embodiment, the request message is transmitted by sidelink communication, but may instead be transmitted by communication through the base station 200.

In step S403, the vehicle 100B to 100D transmits the communication quality information stored in the storage 112 to the vehicle 100A in response to reception of the request message. More specifically, the vehicle 100B to 100D transmits, to the vehicle 100A, a communication quality message including position information stored in the storage 112 and the communication quality information about a position indicated by the position information. The communication quality information to be transmitted may be an immediately preceding measurement result, or may be a plurality of measurement results for an immediately preceding predetermined period of time, or may be a measurement result for a predetermined area (such as within a predetermined distance of the current position of the vehicle 100A).

In step S404, the vehicle 100A determines a position with a high communication quality as a destination, based on the obtained communication quality information. At this time, the vehicle 100A may determine the destination by using the communication quality information that the vehicle 100A itself measured. In the present disclosure, “high communication quality” may mean that the communication quality satisfies a predetermined standard, for example. The “predetermined standard” may be any standard that is equal to or higher than the communication quality needed by the vehicle 100A. For example, a condition that the received radio wave strength is at or greater than predetermined strength, that the reception quality is at or greater than a predetermined value, that the signal-to-interference-plus-noise ratio is at or greater than a predetermined value, or that the communication throughput is at or greater than a predetermined value may be adopted. Furthermore, in the case where there are a plurality of positions where the predetermined standard is satisfied, the destination may be determined based on other elements such as a distance from the current position of the vehicle 100A. Furthermore, the vehicle 100A may present candidate destinations to a user of the vehicle 100A to allow the user to make a final decision.

In step S405, the vehicle 100A searches for a route from a current location to the destination determined in step S404, and presents the obtained route to the user in step S406. When the user determines to adopt the route, the vehicle 100A starts guidance according to the route. Additionally, in the case where a plurality of destinations are obtained in step S404, a route for each destination may be presented to the user, and the user may be made to input the destination and the route to be adopted. Furthermore, in the case where the vehicle 100A is an autonomous vehicle, the route may be changed or determined after a confirmation from the user is obtained, or the route may be changed or determined without a confirmation from the user.

### Advantageous Effects

According to the present embodiment, a position with a good communication quality, including a position that is not traveled by the vehicle, can be grasped, and large-capacity communication can be performed by moving to such a position. Additionally, the same can be said for when a communication quality map created based on a statistical communication quality is used, but the communication quality may change over time, and thus, the communication quality indicated by the map is not necessarily accurate. According to the present embodiment, a communication quality that is obtained based on immediately preceding measurement is used, and thus, highly accurate information can be grasped.

### Second Embodiment

In the first embodiment, the destination is determined based on the communication quality information, but in a present embodiment, the destination is given, and a route to the destination is determined based on the communication quality information that is obtained from a vehicle in the surroundings.

An overall configuration of the system (FIG. 1), the configuration of the vehicle 100 (FIG. 2), and the flow of the acquisition process for the communication quality information by the vehicle 100 (FIG. 3) are the same as those in the first embodiment, and a redundant description will be omitted.

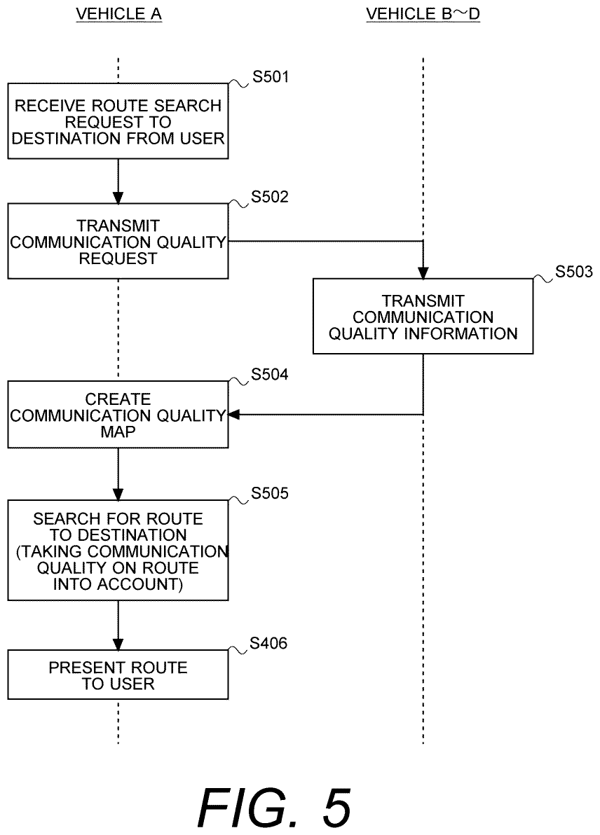

FIG. 5 is a flowchart illustrating a flow of processes that are performed at a time when the vehicle 100A starts to move to the destination.

In step S501, the vehicle 100A receives a route search request to the destination from the user, and the processes in FIG. 5 are thus started. Additionally, the processes in FIG. 5 may be performed during traveling on a determined route.

In step S502, the vehicle 100A transmits a request message requesting the communication quality information to the vehicle 100B to 100D in the surroundings via the wireless communication unit 120. The request message may include an identifier of the vehicle 100A and a current position of the vehicle 100A. In the present embodiment, the request message is transmitted by sidelink communication, but may instead be transmitted by communication through the base station 200.

In step S503, the vehicle 100B to 100D transmits the communication quality information stored in the storage 112 to the vehicle 100A in response to reception of the request message. More specifically, the vehicle 100B to 100D transmits, to the vehicle 100A, a communication quality message including position information stored in the storage 112 and the communication quality information about a position indicated by the position information. The communication quality information to be transmitted may be an immediately preceding measurement result, or may be a plurality of measurement results for an immediately preceding predetermined period of time, or may be a measurement result for a predetermined area (such as within a predetermined distance of the current position of the vehicle 100A).

In step S504, the vehicle 100A creates a communication quality map based on the communication quality information obtained. The communication quality map is a map indicating the communication quality at each position or each road.

In step S505, the vehicle 100A searches for a route to the destination based on the communication quality map that is created, by taking into account the communication quality of the route. Route search that takes communication quality into account is a search that is performed by preferentially searching for a route where the communication quality is at or higher than a predetermined standard while excluding a route that does not satisfy the predetermined standard, for example. Such search may be achieved by setting a great movement cost for a road that does not satisfy the predetermined standard. Additionally, various methods are conceivable in relation to the standard for route search. For example, there are a method that is based on an average communication quality of an entire route, and a method of searching for a route that does not pass through a part where the communication quality is lower than the standard. The former is effective when performing communication of a predetermined amount, and the latter is effective when continuously performing communication. Additionally, in the case where a time slot when a communication quality needs to be secured is grasped in advance, route search that takes communication quality into account only with respect to the time slot may be performed.

In step S506, the obtained route is presented to the user. When the user determines to adopt the route, the vehicle 100A starts guidance according to the route. Furthermore, in the case where the vehicle 100A is an autonomous vehicle, the route may be changed or determined after a confirmation from the user is obtained, or the route may be changed or determined without a confirmation from the user.

### Advantageous Effects

According to the present embodiment, a position with a good communication quality, including a position that is not traveled by the vehicle, can be grasped, and a route with a good communication quality can thereby be presented in relation to the destination. Because traveling is performed along a route with a good communication quality all the way (or in a necessary period) during movement to the destination, the user may enjoy a good communication service.

### Third Embodiment

The first and second embodiments describe an example where the mobile body moves to a position with a good communication quality by taking into account the communication quality in the surroundings, and an example where the mobile body moves by passing through a position with a good communication quality. A present embodiment proposes that communication be performed through a wireless communication device that is present at a position with a good communication quality, instead of the device itself moving.

An overall configuration of a system according to the present embodiment is the same as that in the first and second embodiments and is as illustrated in FIG. 1, but a component of the system is a user terminal (wireless communication device) and not the vehicle. However, the user terminal may be mounted on a vehicle or on a different mobile body. The user terminal may instead be carried by a person, or may be fixed at one position. That is, the user terminal according to the present embodiment may or may not be movable.

Like the vehicle 100 illustrated in FIG. 2, the user terminal according to the present embodiment includes the controller 110, the wireless communication unit 120, and the GPS device 130. Additionally, the user terminal including such components is assumed to be the wireless communication device.

The flow of the acquisition process for the communication quality information (FIG. 3) performed by the user terminal according to the present embodiment is the same as that in the first and second embodiment, and a description thereof will be omitted.

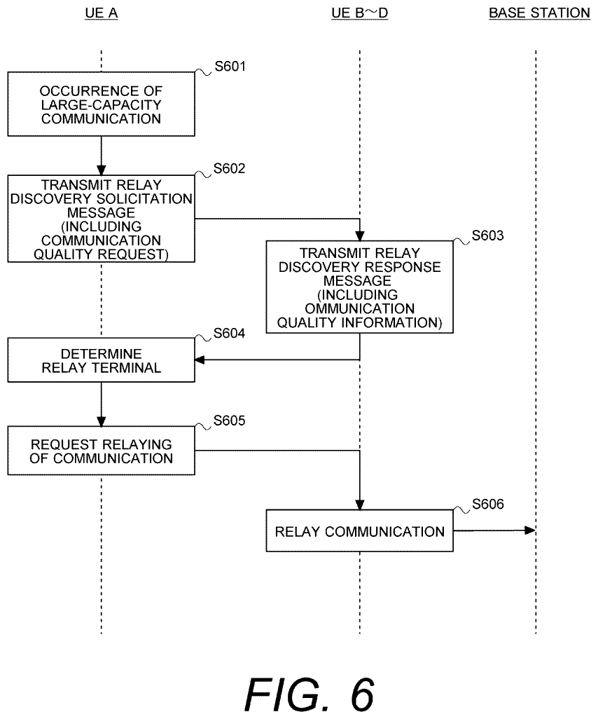

FIG. 6 is a flowchart illustrating a flow of processes that are performed at the time of the user terminal performing large-capacity communication. The following description describes that the user terminal performs the processes, but more precisely, the processes are performed by the controller 110 of the user terminal.

The processes in FIG. 6 are started when there is occurrence of a request for large-capacity communication at the user terminal in step S601. Additionally, a request for large-capacity communication includes, in addition to a case where communication is to be instantly started, a case where communication is scheduled to be performed after a predetermined period of time. Additionally, the need for large-capacity communication is merely an example of a trigger for the present processes, and any other start of communication may be taken as the trigger for the present processes.

In step S602, a user terminal A transmits a relay discovery solicitation message to a user terminal in the surroundings via the wireless communication unit 120. The relay discovery solicitation message according to the present embodiment includes a parameter for requesting the communication quality information. The relay discovery solicitation message may include an identifier of the user terminal A and a current position of the user terminal A. In the present embodiment, the relay discovery solicitation message is transmitted by sidelink communication, but may instead be transmitted by communication through the base station 200.

In step S603, a user terminal B to D determines whether communication from another user terminal can be relayed or not, and in the case where relaying is possible, the user terminal B to D transmits a relay discovery response message to the user terminal A. The relay discovery response message includes the communication quality information. More specifically, the communication quality information includes position information and the communication quality at a position indicated by the position information. The communication quality information to be transmitted may be an immediately preceding measurement result, or may be a plurality of measurement results for an immediately preceding predetermined period of time, or may be a measurement result for a predetermined area (such as within a predetermined distance of the current position of the user terminal A). The relay discovery response message may be taken to be the communication quality message.

In step S604, the user terminal A determines, as a relay terminal, a user terminal that is capable of relaying and that is in a state of good communication quality, based on the communication quality information included in the relay discovery response message. In the present disclosure, “high communication quality” may mean that the communication quality satisfies a predetermined standard, for example. The “predetermined standard” may be any standard that is equal to or higher than the communication quality needed by the user terminal A. For example, a condition that the received radio wave strength is at or greater than predetermined strength, that the reception quality is at or greater than a predetermined value, that the signal-to-interference-plus-noise ratio is at or greater than a predetermined value, or that the communication throughput is at or greater than a predetermined value may be adopted. Furthermore, in the case where there are a plurality of user terminals that satisfy the predetermined standard, the relay terminal may be determined based on other elements such as a distance from the current position of the user terminal A. Furthermore, the user terminal A may present candidate relay terminals to a user of the user terminal A to allow the user to make a final decision.

In step S605, the user terminal A requests the relay terminal that is determined, to relay communication through the base station 200. In step S606, in response to the request for relaying, the relay terminal transmits requested communication to the base station 200. Additionally, in a case where a response to the user terminal A is received from the base station 200, the relay terminal transmits the response to the user terminal A.

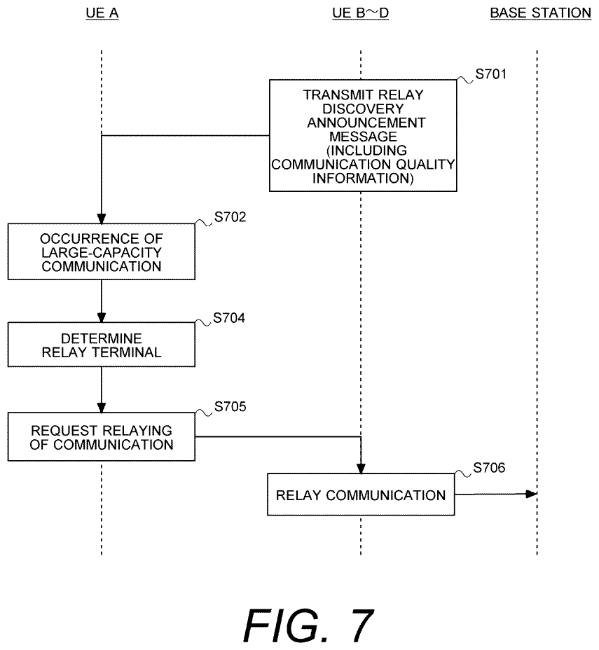

FIG. 7 is a flowchart illustrating a flow of the process according to a modification of the present embodiment. In the present embodiment, each user terminal transmits a relay discovery announcement message to surroundings when relaying of communication is possible (step S701). The relay discovery announcement message includes the communication quality information. The communication quality information to be transmitted may be an immediately preceding measurement result, or may be a plurality of measurement results for an immediately preceding predetermined period of time. The relay discovery announcement message is transmitted by sidelink communication, but may instead be transmitted by communication through the base station 200.

When there is occurrence of a request for large-capacity communication in step S702, the user terminal A determines a relay terminal in step S704 based on the relay discovery announcement message that is received. Additionally, the user terminal A may determine the relay terminal based on the relay discovery announcement message that is received after occurrence of a request for large-capacity communication. A selection standard for the relay terminal is the same as described above. Processes in steps S704 to S706 are the same as the processes in steps S604 to S606, and a description thereof will be omitted.

### Advantageous Effects

According to the present embodiment, by performing communication via another wireless communication device that is at a position where quality of communication with the base station is good, a wireless communication device is able to perform large-capacity communication without moving to a position with a good communication quality. Furthermore, load balancing by which communication load of each user terminal is distributed is enabled. Particularly, efficient load balancing is enabled by selecting, as the relay terminal, a user terminal with high communication throughput in terms of communication quality.

### Other Modifications

The embodiments described above are merely examples, and the present disclosure may be changed as appropriate within the scope of the gist of the disclosure.

The embodiments described above describe an example where mobile communication according to 5G standards (communication through a base station and sidelink communication) is used, but communication according to any standard may be adopted as long as the communication is wide-area wireless communication through a base station or an access point or direct communication between vehicles or user terminals. Examples of wide-area wireless communication include wire-area wireless LAN (IEEE 802.11ah) and WiMax (IEEE 802.6). Examples of direct communication between vehicles or user terminals include WiFi-Direct and Bluetooth (registered trademark).

The present disclosure may also be implemented by supplying computer programs for implementing the functions described in the above embodiments to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. A mobile body comprising a wireless communication unit and a processor, wherein the processor is configured to:
receive communication quality messages from a plurality of other mobile bodies by the wireless communication unit, the communication quality messages including position information and communication quality information about a position indicated by the position information,
determine a destination based on the communication quality messages, and
present information about the destination to a user.

2. The mobile body according to claim 1, wherein the processor determines, as the destination, a position where communication quality is at or higher than a predetermined standard.

3. The mobile body according to claim 1, wherein information about the destination is a route to the destination.

4. The mobile body according to claim 1, wherein communication quality is a received radio wave strength, a reception quality, a signal-to-interference-plus-noise ratio, or communication throughput.

5. A mobile body comprising a wireless communication unit and a processor, wherein the processor is configured to:
receive communication quality messages from a plurality of other mobile bodies by the wireless communication unit, the communication quality messages including position information and communication quality information about a position indicated by the position information,
create a communication quality map for each position based on the communication quality messages, and
search for a route to a destination based on the communication quality map, and present the route to a user or move along the route.

6. The mobile body according to claim 5, wherein the processor
receives a route search request including a destination from the user,
transmits a request message requesting the communication quality message to the other mobile bodies, in response to the route search request, and
searches for a route to the destination using a communication quality map created based on the communication quality message obtained by the request message, and presents the route to the user.

7. The mobile body according to claim 5, wherein the processor preferentially searches for a route where a communication quality is at or higher than a predetermined standard, based on the communication quality map.

8. The mobile body according to claim 5, wherein the processor is further configured to determine a position with a high communication quality as the destination.

9. The mobile body according to claim 5, wherein communication quality is a received radio wave strength, a reception quality, a signal-to-interference-plus-noise ratio, or communication throughput.

10. A wireless communication device comprising a processor configured to:
receive communication quality information from a plurality of other wireless communication devices,
select at least one wireless communication device from the plurality of other wireless communication devices based on the communication quality information, and
request the other wireless communication device that is selected, to relay communication through a base station.

11. The wireless communication device according to claim 10, wherein the processor
transmits a request message requesting the communication quality information to the plurality of other wireless communication devices, and
selects at least one wireless communication device from the plurality of other wireless communication devices based on the communication quality information obtained by the request message.

12. The wireless communication device according to claim 10, wherein the wireless communication device is a wireless communication device that performs mobile wireless communication.

13. The wireless communication device according to claim 10, wherein
communication quality is a received radio wave strength, a reception quality, a signal-to-interference-plus-noise ratio, or communication throughput, and
the processor selects the wireless communication device with highest received radio wave strength, highest reception quality, highest signal-to-interference-plus-noise ratio, or highest communication throughput.
